(19) United States
(12) Patent Application Publication
(10) Pub. No.: US 2025/0036813 A1
(43) Pub. Date: Jan. 30, 2025

(54) MANAGING THREATS TO DATA STORAGE IN DISTRIBUTED ENVIRONMENTS

(71) Applicant: Dell Products L.P., Round Rock, TX (US)

(72) Inventors: ARIEH DON, Newton, MA (US); EFI LEVI, Beer Sheva (IL); LIOR BENISTY, Beer Sheva (IL); CHING-YUN CHAO, Austin, TX (US)

(21) Appl. No.: 18/358,272

(22) Filed: Jul. 25, 2023

(51) Int. Cl. G06F 21/64; G06F 21/60

(52) U.S. Cl. CPC G06F 21/64; G06F 21/602

(57) ABSTRACT

Methods and systems for managing data storage are disclosed. The storage of data may be managed by implementing a framework for checking whether payloads requested for storage have been modified prior to storage. The checks may be performed using integrity verification data that is based on corresponding payloads and keys. The payloads and integrity verification data may be directed to storage along a storage pipeline. The integrity of the payloads may be verified along the storage pipeline. Once received, the storage may perform the checks using the integrity verification data as a final check before storage.

### FIELD

Embodiments disclosed herein relate generally to data integrity. More particularly, embodiments disclosed herein relate to systems and methods to manage the integrity of data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show data flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data storage. When computer implemented services are provided, data may be generated and stored for future use by applications that participate in the computer implemented services.

However, the applications may pass the data to other intermediary entities during transit to storage where the data is stored. In transit, the data may be at risk of being modified due to, for example, action of malicious entities (e.g., ransomware), errors in operation of the intermediary entities, and/or other factors. Consequently, if the modified data is stored without the modifications being identified, the applications my believe that the data is retrievable from storage while the data is not actually retrievable.

To improve the likelihood of data generated by applications being retrievable from storage, the applications may obtain integrity verification data for payloads (e.g., data that may be retrieved from storage in the future and used by the application). The integrity verification data may allow for identification of when modifications to the payload have been made after the payload has left possession of the application (e.g., in transit to storage).

The integrity verification data may include a message authentication code, or other cryptographically verifiable data structure. The integrity verification data may be obtained using a trusted platform module or other secret keeping component, and which may provide its functionality using a secret that it maintains.

When data (that includes both payload and integrity verification data) is obtained by storage arrays or other entities along a storage pipeline, the data may be subjected to a verification process which checks for signs that the payload and/or integrity verification data has been modified. The verification process may also utilize the trusted platform module, and secret it maintains. If it is determined that data has been modified, then a request for storing the data may be refused. By refusing to store the data that is likely to have been modified, an application that requested storage of the data may not be lulled into a false belief that the payload from the data is retrievable from storage in the future.

By doing so, embodiments disclosed herein may improve the likelihood that data generated by applications and sent for storage is retrievable from storage in the future. The disclosed embodiments may do so by adding additional data to a payload usable to identify whether any modifications have been made after the data leaves control of the applications. Thus, embodiments disclosed herein may address, among others, the technical problem of loss of access to data due to malicious or other types of undesired activity in a system.

In an embodiment, a method for managing storage of data is provided. The method may include obtaining the data for storage from an application; obtaining an authentication code for the data from a management layer; adding the data and authentication code to a storage pipeline to store the data in a storage array, the storage pipeline comprising a driver for the storage array and the storage array; while the data traverses the storage pipeline, attempting to verify integrity of the data using the authentication code to obtain at least one integrity verification outcome; making a determination regarding whether the at least one integrity verification outcome indicate that the data successfully traversed the storage pipeline; in a first instance of the determination where the at least one integrity verification outcome indicates that the data successfully traversed the storage pipeline: storing the data in the storage array; and in a second instance of the determination where the at least one integrity verification outcome indicates that the data unsuccessfully traversed the storage pipeline: discarding the data without storing the data in the storage array.

Obtaining the authentication code may include invoking a security function of the management layer, the security function of the management layer generating the authentication code using a symmetric key.

The symmetric key may be maintained by a trusted platform module, the trusted platform module generating the authentication code without providing access to the symmetric key.

Attempting to verify the integrity of the data may include invoking a second security function of the management layer, the second security function evaluating the integrity of the data using the authentication code and the symmetric key.

The management layer may be programmed to deny use of the security function for data from the application without verifying integrity of the application.

The method may also include, prior to obtaining the data: verifying the integrity of the application using an image of the application and a hash for the image.

The trusted platform module may be adapted to verify an integrity of the hash for the image prior to enabling use of the symmetric key, and deny use of the symmetric key when the hash cannot be verified.

During the attempting to verify the integrity of the data, a first attempt to verify the integrity of the data may be made when the data reaches the driver along the storage pipeline and a second attempt to verify the integrity may be made when the data reaches a storage management layer of the storage array.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

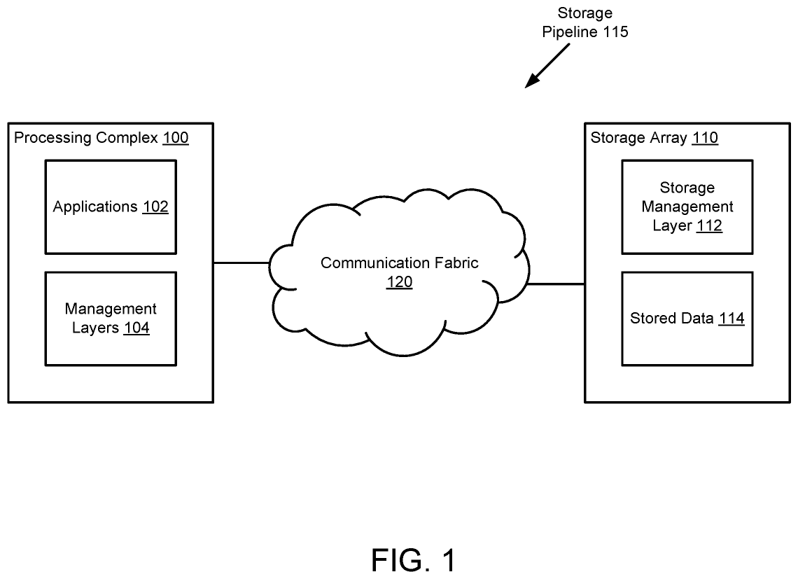

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, data may be generated and stored for future use. Any type and quantity of data may be generated and stored.

Previously stored data may be used to provide the computer implemented services. For example, if the computer implemented services include database services, then data may be stored for future use to service future requests for information stored as part of the database services. If the data is not accessible in the future, then the computer implemented services may not be available, may not be successfully provided, and/or may otherwise be impacted.

Stored data may be inaccessible for a number of different reasons including, for example, activity by a malicious entity. After data is generated and/or routed to storage for retention (e.g., after leaving control of a generator of the data), the malicious entity may modify the data prior to the data being stored. In the context of malware based attacks, the malicious entity may encrypt the data using a secret cypher prior to the now-encrypted data being stored. Consequently, the encrypted data may be stored in place of the intended to be stored data. If read from storage, the data may not be recovered from the encrypted data without the secret cypher. A malicious party may then attempt to extract concessions in exchange for access to the secret cypher to allow recovery of the data from the encrypted data.

In general, embodiments disclosed herein may provide methods, systems, and/or devices for managing storage of data in a manner that improves the likelihood of the data being readable (or otherwise accessible) from storage in the future. To manage the storage of the data, integrity verification data may be added to a payload of data for which access in the future is desired (e.g., to obtain verifiable data) and prior to traversing a storage pipeline (e.g., 115). The integrity verification data may be generated and added to the data prior to the data traversing through a system where a malicious entity may interact with the data. For example, the integrity verification data may be added to the data by a management service (e.g., such as a functionality of an operating system or other type of management entity) invoked by the application.

The integrity verification data may include information usable to ascertain whether the data has been modified after generation by the application. For example, the integrity verification data may include a message authentication code (e.g., a keyed-hash message authentication code (HMAC), hash-based message authentication code, and/or other types of codes) and/or other type of cryptographic data usable to verify the integrity of the data. The message authentication code may be generated using a cryptographic hash function (e.g., HMAC-SHA256) using the data as a payload, and a symmetric key. The symmetric key may be maintained by a hardware security device such as a trusted platform module. Consequently, a management entity may gate use of the symmetric key.

For example, to reduce the likelihood of the symmetric key by malicious entities, the management entity may restrict the ability of other entities to invoke use of the key to generate message authentication codes and to use the symmetric key to authentication the integrity of data using the symmetric key and previous generated message authentication codes. The management entity may require that the invoking entities pass integrity verification checks such as verifying that software images of the entities match hashes of software images that are known to be for trusted software components. If the integrity of the invoking entities cannot be verified, then use of the symmetric key may be denied. The hashes of the software images may also be checked such as through adding the hashes to a database (e.g., such as an extensible firmware database). During startup of a data processing system, the integrity of these hashes may be verified. The trusted platform module may deny use of the symmetric key if these hashes cannot be verified.

Returning to the discussion of the storage pipeline, as the data and integrity verification data traverse the storage pipeline (e.g., generator such as an application, management entities such as drivers used to initiate storage of the data by a storage system, the storage system, etc.), the integrity of the data may be verified. For example, when the data is obtained by a driver, the driver may invoke functionality of the management entity to authenticate the integrity of the data using the integrity verification data.

Similarly, when data is obtained by a storage, the storage may attempt to verify that the data has not been modified in transit from the application using the integrity verification data. For example, the storage may invoke the functionality of the management entity as well.

If received data can be verified by the driver, storage, and/or other entity along the storage pipeline, then the data may be forwarded along the storage pipeline and/or stored in the storage for future use (e.g., including the integrity verification data). If the received data cannot be verified, then the data may eject (e.g., discarded without forwarding) from the storage pipeline and/or may not be stored, and/or a write failure may be issued. Issuing the write failure may signal to the application (or other entity requesting storage of data) that the data will not be available in the future thereby prompting the application to take additional action (e.g., attempting to write the data elsewhere, initiating malware sweeps, etc.). In addition, when write failures are issued (or sufficient numbers of write failures meeting criteria are issued), alerts or other information may be sent to management entities indicating that a malicious entity may be attempting to interfere with data storage.

By doing so, a system in accordance with an embodiment may be more likely to be able to access stored data in the future by reducing the likelihood that the to-be-stored data is modified while in transit for storage and/or otherwise out of the control of an application for which the data is to-be-stored.

To provide the above noted functionality, the system of FIG. 1 may include processing complex 100 and storage array 110. Each of these components is discussed below.

Processing complex 100 may be implemented with one or more processors (of any type) and memory devices. When operable, processing complex 100 may host any number of entities including, for example, applications 102 and management layers 104. Processing complex 100 may be part of a data processing system.

Applications 102 may contribute to the computer implemented services provided by the system of FIG. 1. For example, applications 102 may perform all, or a portion, of the computer implemented services. During their operation, applications 102 may generate data which may need to be accessed in the future.

To improve the likelihood of the data being retrievable in the future, applications 102 may add message authentication codes (or other types of cryptographic data that may be checked with a key, the codes may be obtained from management layers 104) to the data to obtain verifiable data. The verifiable data may be synthesized using a rubric, a set of rules, a template, schema (e.g., a data structure construction schema), or other tool usable to define how verifiable data is generated (e.g., may define the structure, where different portions of data are positioned within the verifiable data, etc.).

Once synthesized, applications 102 may pass the verifiable data to management layers 104 (which may include, for example, a driver for storage array 110) which may manage the storage of the verifiable data in storage array 110. However, during transit from applications 102 to storage array 110 along a storage pipeline that includes management layers 104, the verifiable data may be modified by malicious entities such as malware hosted by processing complex 100, or other processing complexes or entities (e.g., positioned along the storage pipeline between processing complex 100 and storage array 110). However, by including integrity verification data in the verifiable data, management layers 104 and storage array 110 may identify whether the received data has been modified in transit.

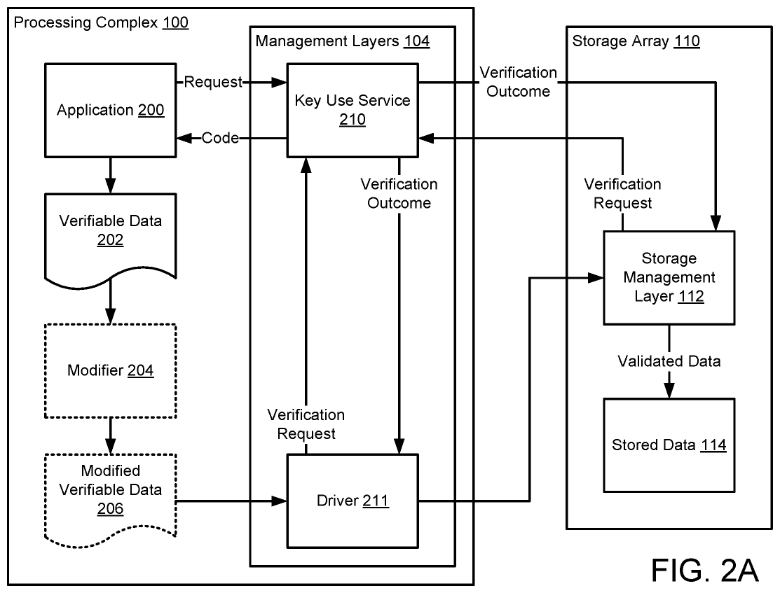

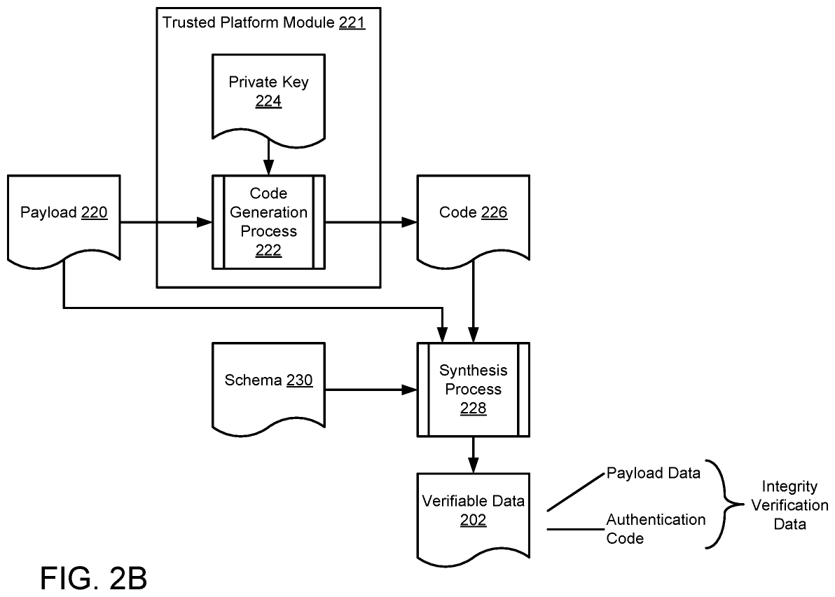

Management layers 104 may provide management functionality for processing complex 100. For example, management layers 104 may include an operating system, drivers, trusted platform modules, and/or other entities. The operating system and drivers may manage the storage of data on behalf of applications 102 in storage array 110. The trusted platform modules may manage symmetric keys (e.g., used for message authentication code generation/verification of data) and implement cryptographic functions to use the keys to generate message authentication codes and/or use the message authentication codes to verify corresponding data. However, once the data leaves possession of applications 102, malicious entities may modify the data prior to and/or while in custody of management layers 104 and storage array 110 through a variety of different types of modalities. If successfully modified by the malicious entities, the data may not be easily recovered from the modified data. For example, if modified data is an encrypted form of the data, then the data may not be recoverable without access to encryption/decryption keys used to encrypt the data. Consequently, even if stored, the modified data may not be usable to retrieve the data in the future. Refer to FIG. 2A for additional details regarding modification of data while in transit from applications 200 to storage array 110.

Storage array 110 may be implemented with one or more storage devices (of any type), storage controllers (which may include processors and memory), and/or other devices. Storage array 110 may store data for applications 102 and/or other entities.

To improve the likelihood of stored data being accessible in the future, storage array 110 may screen data for indications of having been modified while in transit from (or otherwise being out of the control of) applications 102, similarly to drivers of management layers 104 and/or other entities (not shown) positioned along the storage pipeline. To do so, storage array 110 may host storage management layer 112 (e.g., an application, embedded software, a function performed by a discrete hardware device, etc.). Storage management layer 112 may perform verifications for data as it is received by storage array 110 for storage. Storage array 110 may presume that the received data conforms to the schema used by applications 102 to generate verifiable data, and may attempt to use integrity verification data from the data and/or functionality of management layers 104 to verify the data. Refer to FIG. 2B for additional details regarding generation of verifiable data and verification of data.

If the integrity of the data is successfully verified, storage management layer 112 may store the data as stored data 114 (e.g., in the storage devices (not shown) of storage array 110). If the data is unable to be verified, storage management layer 112 and/or other entities along the storage array may issue a write error for the data thereby notifying applications 102 that the data will not be available in the future (e.g., unless additional action is taken to store it). Additionally, storage management layer 112 may send notifications and/or other information to management entities. The notifications may trigger remediations such as screenings of processing complex 100, storage array 110, and/or other components along the storage pipeline for presence of malware or other malicious entities. If detected, the malware may be removed to reduce the likelihood of data being modified while transiting between applications 102 and storage array 110 in the future.

As used herein, a storage pipeline may be a logical collection of components (software/hardware) that have the ability to modify data after generation by a data source (e.g., applications 102) and prior to storage of the data. The components may include components that take temporary custody of the data, pass the data through, and/or otherwise interact with the data as it traverses from the data store to a destination storage.

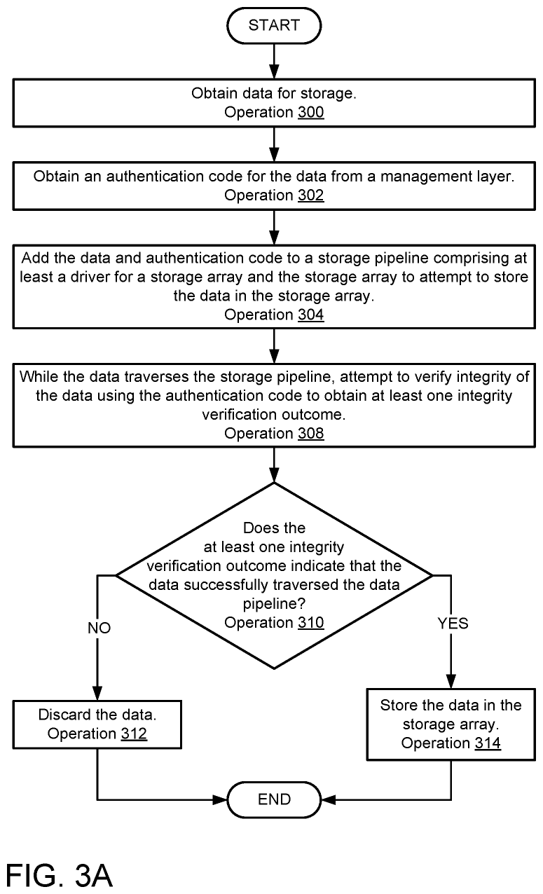

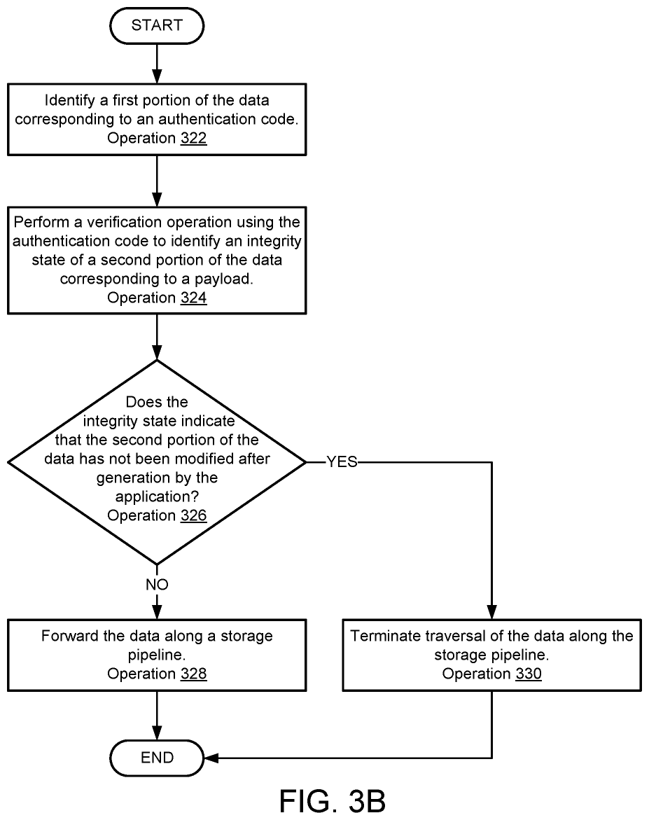

When providing their functionality, any of processing complex 100 and storage array 110 may perform all, or a portion, of the methods illustrated in FIGS. 3A-3B.

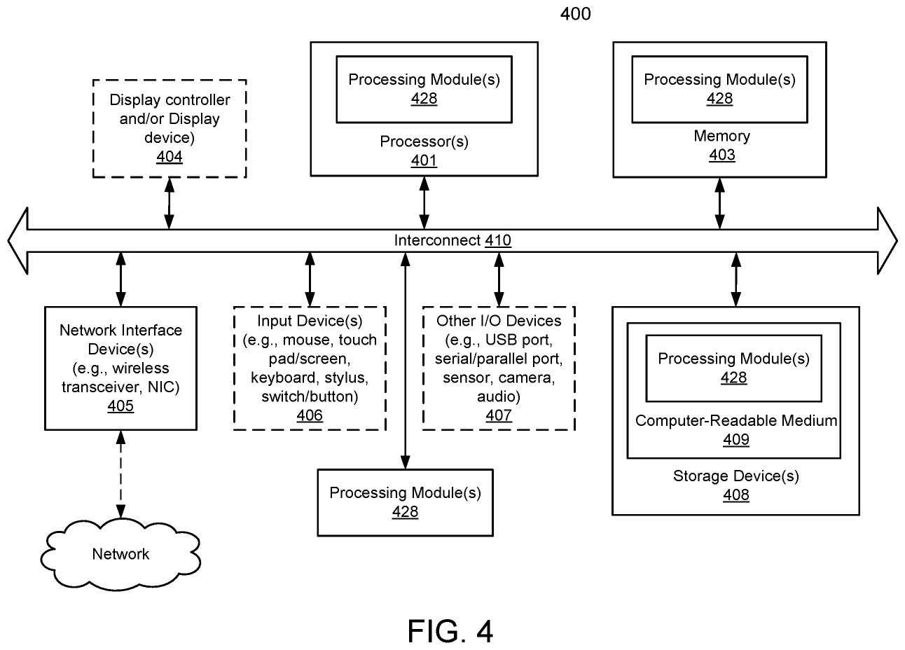

Processing complex 100 and storage array 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

While described with respect to storage array 110, it will be appreciated that the system of FIG. 1 may include a single storage device which may provide the functionality of storage array 110. Additionally, it will be appreciated that processing complex 100 and storage array 110 may be collocated or separated geographically from one another.

Any of the components illustrated in FIG. 1 may be operably connected to each other (and/or components not illustrated) with communication fabric 120. Communication fabric 120 may facilitate communications between processing complex 100 and storage array 110. In an embodiment, communication fabric 120 includes one or more networks that facilitate communication between any number of components, fiber channel or other types of communication links (e.g., that support Small Computer System Interface (SCSI) based interfaces and data transfer between devices), network interface cards, and/or other types of communication devices. The networks may include wired networks and/or wireless networks (e.g., and/or the Internet). The networks and communication devices may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

As discussed above, a malicious entity may attempt modify data as it is in transit from an application to storage. To reduce the impact of such activity, the system shown in FIG. 1 may generate and use message authentication codes to detect modifications of data while in transit.

Turning to FIG. 2A, a first data flow diagram in accordance with an embodiment is shown. In FIG. 2A, entities of a system that may perform activities are shown using a first set of shapes (e.g., 200, 204, 104, 210, 212, 112, 114), and data structures in transit between the entities (e.g., along a storage pipeline) are shown using a second set of shapes (e.g., 202, 206).

Now, consider an example scenario in which application 200 hosted by processing complex 100 generates data (e.g., a payload) which may need to be accessed in the future. Application 200 may use storage services provided by storage array 110 to store and access the payload.

However, to provide the payload to storage array 110 for storage, application 200 may rely on other entities hosted by processing complex 100 such as management layers 104 (e.g., driver 211 of management layer 104). Consequently, application 200 may need to pass the payload to any number of intermediate entities along a storage pipeline before the payload reaches storage array 110. However, the payload may not natively include features to verify its integrity. Accordingly, a malicious entity may modify the content of the payload with little chance of the modification being detectable by storage array 110, driver 211, and/or other entities along the storage pipeline.

To manage the integrity of the payload, application 200 may invoke functionality of key use service 210 generate and transmit verifiable data 202 rather than the payload on its own. Verifiable data 202 may include integrity verification data (e.g., a message authentication code) usable to ascertain whether the payload of verifiable data 202 has been modified after generation by application 200.

Key use service 210 may utilize functionality of a trusted management platform in response to requests from application 200. The trusted platform module may use a cryptographic function and a symmetric key (which it maintains) to generate a message authentication code. Once generated, the message authentication code may be appended to the data in a particular manner to obtain verifiable data 202). Refer to FIG. 2B for additional details regarding generation of verifiable data 202.

Once generated, application 200 may pass verifiable data 202 to other entities hosted by processing complex 100, such as driver 211 of management layers 104 to initiate storage in storage array 110. However, during transit, modifier 204 (if present, drawn with a dashed outline to indicate that modifier 204 and modified verifiable data 206 may not always be present) may modify the content of verifiable data 202. For example, modifier 204 may represent ransomware, malware, or other types of entities which may modify the content of verifiable data 202 along the storage pipeline. In another example, modifier 204 may represent software that is not malicious but operating in an undesired manner resulting in modification of data in transit along the storage pipeline between application 200 and storage array 110.

The resulting modified verifiable data 206 due to modifier 204 may, if stored in storage array 110, make the previously generated payload inaccessible. For example, if modifier 204 encrypts verifiable data 202, then the payload as encrypted within the stored copy of modified verifiable data 206 may not be used to recovery the payload without the encryption key (e.g., and/or other types of information used to cypher the payload) used by modifier 204.

However, when modified verifiable data 206 is obtained by driver 211, storage management layer 112, and/or other entities along the storage pipeline, an integrity verification process may be performed prior to forwarding the data along the storage pipeline and/or storing modified verifiable data 206 as stored data 114. Because the verification process will fail due to the modification made to verifiable data 202, driver 211, storage management layer 112, and/or other entities along the storage pipeline may reject modified verifiable data 206 for storage/continued traversal of the storage pipeline. Accordingly, application 200 and/or other entities will not rely on a stored copy of modifiable verifiable data 206 in the future for accessing the previously generated payload. Rather, application 200 may interpret the rejection as a write failure, and may take appropriate action (e.g., attempting to perform additional writes for the data, taking other remedial actions, etc.).

However, to perform the verification, a message authentication code may need to be used. For example, driver 211, storage management layer 112, and/or other entities along the storage pipeline may utilize the functionality of key use service 210 (and the corresponding trusted platform module). These entities may invoke verification functionality which may be provided by the trusted platform module. The trusted platform module may use the message authentication code from modified verifiable data 206 and the previously used symmetric key to check the integrity of the payload (e.g., by attempt to regenerate the message authentication code, and comparing the newly generated message authentication code to the message authentication code of modified verifiable data).

Turning to FIG. 2B, a second data flow diagram in accordance with an embodiment is shown. The second data flow diagram may illustrate processes performed by and data structures used in obtaining verifiable data. In FIG. 2B, processes that are performed are shown using a first set of shapes (e.g., 222, 228), and data structures are shown using a second set of shapes (e.g., 220, 224, 226, 232).

To obtain verifiable data 202, payload 220 (e.g., generated by an application) may be ingested by code generation process 222 (e.g., a function of trusted platform module 221). During code generation process 222, code 226 may be generated. Code 226 may be a portion of data derived, at least in part, on payload 220 and private key 224 (e.g., using a code derivation function such as HMAC-SHA256) and usable to verify whether payload 220 has been modified. For example, code 226 may be a one way result of a one way function with payload 220 and private key 224 as ingests to the one way function. The one way function may be, for example, a hash function and the one way result may be a cryptographic hash function performed on payload 220 with private key 224 dictating part of the cryptographic hash generation process. The hash may be used to ascertain whether payload 220 has been modified by (i) when obtained by a storage array or other entities along a storage pipeline, calculation of another instance of code 226 for the payload (e.g., by trusted platform module 221), and (ii) comparing the other instance of code 226 to code 226 as previously generated for payload 220. If the newly generated other instance of code 226 matches the previously generated instance of code 226, then code 226 224 may indicate that payload 220 in the received data has not been modified during transit.

Once code 226 is obtained, then verifiable data 202 may be obtained via synthesis process 228. During synthesis process 228, payload 220 and code 226 may be arranged in a manner as specified by schema 230. Schema 230 may specify a structure for verifiable data 202. The structure may indicate where payload 220 and code 226 are to be positioned within verifiable data 202. For example, schema 230 may specify offsets for each of these portions of verifiable data 202, may specify the lengths of each of these portions, etc.

Thus, verifiable data 202 may include different portions corresponding to payload data and integrity verification data. The integrity verification data may include code 226. The storage array and/or other entities along a storage pipeline may be aware of schema 230 and may perform integrity checks on data from verifiable data 202 by invoking functionality of trusted platform module 221 and parsing verifiable data 202 using the information in schema 230.

For example, when data is received by a storage array, the storage array may automatically extract (or otherwise identify) portions of the data corresponding to where payload data and code 226 should be located within verifiable data 202 (e.g., if not modified in transit). The storage array may then initiate integrity checks (e.g., by invoking functionality of trusted platform module 221) on these respective portions.

By doing so, a system in accordance with embodiments disclosed herein may identify whether the integrity of payload 220 has been compromised after generation by an application.

The functionality (e.g., code generation process 222, synthesis process 228) shown in FIG. 2B may be performed natively by an application, through invocation of functionalities of other entities such as management layers/hardware devices, and/or in an otherwise secure manner.

As discussed above, the components of FIG. 1 may perform various methods to verify operations to manage the operation of endpoint devices. FIGS. 3A-3B illustrates a method that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for storing data in storage in accordance with an embodiment is shown. The method may be performed by any of processing complex 100, storage array 110, and/or other components of the system shown in FIG. 1.

At operation 300, data for storage is obtained. The data may be obtained by an application. The application may generate the data. The application may need access to the data in the future to continue to provide computer implemented services.

At operation 302, an authentication code for the data is obtained from a management layer. The authentication code may be obtained by invoking a security function of the management layer. The security function may utilize a trusted platform module to generate the authentication code using a secret (e.g., a symmetric key) maintained by the trusted platform module. The trusted platform module may limit use of the secret to only those entities that have been cryptographically verified (e.g., using a trusted hash of an image of the entity).

At operation 304, the data and authentication code are added to a storage pipeline. The storage pipeline may include at least a driver for a storage array (or other type of storage system) and the storage array. Adding the data and authentication code to the storage array may initiate an attempt to store the data in the storage array. The data and authentication code may be added to the storage pipeline by forwarding the data and authentication code to another entity along the storage pipeline. The entity may be the driver. However, once forwarded, malicious entities if present may attempt to modify the data and/or the authentication code.

At operation 308, while the data traverses the storage pipeline, an attempt to verify integrity of the data may be made. The attempt may be made using the authentication code. The at least one attempt may result in at least one verification outcome (e.g., successful or unsuccessful). The attempt may be made by invoking another function of the management layer. The other function may utilize functionality of the trusted platform module to perform a verification algorithm using the symmetric key, authentication code, and the data. For example, the trusted platform module may attempt to generate the authentication code again using the symmetric key. The new and existing authentication codes may be compared to identify whether the verification outcome is successfully verified or unsuccessfully verified (e.g., whether the codes match or do not match). Like use of the trusted platform module for generation of the authentication code, use of the verification functionality of the trusted platform module may be restricted to entities that have been verified as being trusted.

However, as noted above, because the data and/or authentication code may be modified while in transit, the integrity of the data may be checked. If modified, the entity performing the verification may issue a write error which may be provided to the application by the management layers and/or other entities.

At operation 310, a determination is made regarding whether at least one integrity verification outcome indicates that the data successfully traversed the storage pipeline. The at least one integrity verification outcome may indicate that the data successfully traversed the storage pipeline if all of the integrity verification comes are successful.

If it is determined that the data successfully traversed the storage pipeline, then the method may proceed to operation 314. Otherwise the method may proceed to operation 312.

At operation 312, the data may be discarded. Additionally, a write error may be issued. The data may be discarded by not forwarding it along the storage pipeline and/or not storing it depending on where along the storage pipeline the data is located.

Further, other actions may be performed. The other actions may include, for example, issuing an alert, sending notifications to administrators or other persons, etc. The alerts or messages may cause and administrator to initiate review of the processing complex and/or other aspects of a host system by, for example, screening the host system for malicious entities. The other actions may include automatically quarantining various entities along the storage pipeline (e.g., that were along the storage pipeline prior to the data suffering an integrity verification outcome failure).

The method may end following operation 312.

Returning to operation 310, the method may proceed to operation 314 following operation 310 when the data successfully traversed the data pipeline.

At operation 314, the data is stored in the storage array. The authentication code may be stored in the storage array as well. The data and/or authentication code may be stored in the storage array by writing the data and/or the authentication code to one or more storage devices of the storage array.

The method may end following operation 314.

Using the method shown in FIG. 3A, an application may be less likely to rely on data that is believed to be accessible in storage but is not actually accessible in storage due to modification of the data after leaving possession of the application.

Turning to FIG. 3B, a second flow diagram illustrating a method for verifying data in accordance with an embodiment is shown. The method may be performed by any of processing complex 100, storage array 110, and/or other components of the system shown in FIG. 1. For example, the method may be performed by any entity that is attempting to verify the integrity of data flowing along a storage pipeline.

At operation 322, a first portion of the data corresponding to an authentication code is identified. The first portion may be identified based on a schema used by the application to arrange data and an authentication code for the data. The schema may specify the location of the first portion within data traversing a storage pipeline.

At operation 324, a verification operation using the authentication code is performed to identify an integrity state of a second portion of the data corresponding to a payload.

Performing the verification operation may include invoking a security function of a management layer. The security function may utilize a trusted platform module to obtain a new copy of the authentication code, and comparing the new and existing authentication code to determine whether the two match.

At operation 326, a determination may be made regarding whether the security state indicates that the second portion of the data has not been modified after generation by the application. If the new and existing authentication codes match, then it may be determined that the second portion of the data (e.g., the payload) has not been modified. If the new and existing authentication codes do not match, then it may be determined that the second portion of the data has been modified.

If the integrity state indicates that the second portion of the data has not been modified, then the method may proceed to operation 328. Otherwise, the method may proceed to operation 330.

At operation 328, the data is forwarded along the storage pipeline. The data may be forwarded by sending it to another entity in the storage pipeline.

The method may end following operation 328.

Returning to operation 326, if it has been determined that the data has been modified, then the method may proceed to operation 330.

At operation 330, traversal of the data along the storage pipeline may be terminated. The traversal may be terminated by discarding the data without forwarding it along the storage pipeline or storing it.

The method may end following operation 330.

Using the method shown in FIG. 3B, embodiments disclosed herein may facilitate identification of modified data and proactive action to manage the impacts of the modifications to the data. The impacts may be managed by reducing the likelihood of undue reliance of the modified data in the future.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing storage of data, the method comprising:
obtaining the data for storage from an application;
obtaining an authentication code for the data from a management layer;
adding the data and authentication code to a storage pipeline to store the data in a storage array, the storage pipeline comprising a driver for the storage array and the storage array;
while the data traverses the storage pipeline, attempting to verify integrity of the data using the authentication code to obtain at least one integrity verification outcome;
making a determination regarding whether the at least one integrity verification outcome indicate that the data successfully traversed the storage pipeline;
in a first instance of the determination where the at least one integrity verification outcome indicates that the data successfully traversed the storage pipeline:
storing the data in the storage array; and
in a second instance of the determination where the at least one integrity verification outcome indicates that the data unsuccessfully traversed the storage pipeline:
discarding the data without storing the data in the storage array.

2. The method of claim 1, wherein obtaining the authentication code comprises:
invoking a security function of the management layer, the security function of the management layer generating the authentication code using a symmetric key.

3. The method of claim 2, wherein the symmetric key is maintained by a trusted platform module, the trusted platform module generating the authentication code without providing access to the symmetric key.

4. The method of claim 3, wherein attempting to verify the integrity of the data comprises:
invoking a second security function of the management layer, the second security function evaluating the integrity of the data using the authentication code and the symmetric key.

5. The method of claim 3, wherein the management layer is programmed to deny use of the security function for data from the application without verifying integrity of the application.

6. The method of claim 3, further comprising:
prior to obtaining the data:
verifying the integrity of the application using an image of the application and a hash for the image.

7. The method of claim 6, wherein the trusted platform module is adapted to verify an integrity of the hash for the image prior to enabling use of the symmetric key, and deny use of the symmetric key when the hash cannot be verified.

8. The method of claim 1, wherein during the attempting to verify the integrity of the data, a first attempt to verify the integrity of the data is made when the data reaches the driver along the storage pipeline and a second attempt to verify the integrity is made when the data reaches a storage management layer of the storage array.

9. A non-transitory machine-readable medium having instructions stored therein, which when executed by a processor, cause the processor to perform operations for managing storage of data, the operations comprising:
obtaining the data for storage from an application;
obtaining an authentication code for the data from a management layer;
adding the data and authentication code to a storage pipeline to store the data in a storage array, the storage pipeline comprising a driver for the storage array and the storage array;
while the data traverses the storage pipeline, attempting to verify integrity of the data using the authentication code to obtain at least one integrity verification outcome;
making a determination regarding whether the at least one integrity verification outcome indicate that the data successfully traversed the storage pipeline;
in a first instance of the determination where the at least one integrity verification outcome indicates that the data successfully traversed the storage pipeline:
storing the data in the storage array; and
in a second instance of the determination where the at least one integrity verification outcome indicates that the data unsuccessfully traversed the storage pipeline:
discarding the data without storing the data in the storage array.

10. The non-transitory machine-readable medium of claim 9, wherein obtaining the authentication code comprises:
invoking a security function of the management layer, the security function of the management layer generating the authentication code using a symmetric key.

11. The non-transitory machine-readable medium of claim 10, wherein the symmetric key is maintained by a trusted platform module, the trusted platform module generating the authentication code without providing access to the symmetric key.

12. The non-transitory machine-readable medium of claim 11, wherein attempting to verify the integrity of the data comprises:
invoking a second security function of the management layer, the second security function evaluating the integrity of the data using the authentication code and the symmetric key.

13. The non-transitory machine-readable medium of claim 11, wherein the management layer is programmed to deny use of the security function for data from the application without verifying integrity of the application.

14. The non-transitory machine-readable medium of claim 13, further comprising:
prior to obtaining the data:
verifying the integrity of the application using an image of the application and a hash for the image.

15. The non-transitory machine-readable medium of claim 14, wherein the trusted platform module is adapted to verify an integrity of the hash for the image prior to enabling use of the symmetric key, and deny use of the symmetric key when the hash cannot be verified.

16. The non-transitory machine-readable medium of claim 9, wherein during the attempting to verify the integrity of the data, a first attempt to verify the integrity of the data is made when the data reaches the driver along the storage pipeline and a second attempt to verify the integrity is made when the data reaches a storage management layer of the storage array.

17. A system, comprising:
a processor; and
a memory coupled to the processor to store instructions, which when executed by the processor, cause the system to perform operations for managing storage of data, the operations comprising:
obtaining the data for storage from an application;
obtaining an authentication code for the data from a management layer;
adding the data and authentication code to a storage pipeline to store the data in a storage array, the storage pipeline comprising a driver for the storage array and the storage array;
while the data traverses the storage pipeline, attempting to verify integrity of the data using the authentication code to obtain at least one integrity verification outcome;
making a determination regarding whether the at least one integrity verification outcome indicate that the data successfully traversed the storage pipeline;
in a first instance of the determination where the at least one integrity verification outcome indicates that the data successfully traversed the storage pipeline:
storing the data in the storage array; and
in a second instance of the determination where the at least one integrity verification outcome indicates that the data unsuccessfully traversed the storage pipeline:
discarding the data without storing the data in the storage array.

18. The system of claim 17, wherein obtaining the authentication code comprises:
invoking a security function of the management layer, the security function of the management layer generating the authentication code using a symmetric key.

19. The system of claim 18, wherein the symmetric key is maintained by a trusted platform module, the trusted platform module generating the authentication code without providing access to the symmetric key.

20. The system of claim 19, wherein attempting to verify the integrity of the data comprises:
invoking a second security function of the management layer, the second security function evaluating the integrity of the data using the authentication code and the symmetric key.
